(19) United States
(12) Patent Application Publication
(10) Pub. No.: US 2006/0157491 A1
(43) Pub. Date: Jul. 20, 2006

(54) Dispenser with reservoir containing a drug of abuse

(76) Inventors: Brian A. Whittle, Salisbury (GB); Rajiv B Dave, Salisbury (GB)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/563,566

(22) PCT Filed: Jul. 6, 2004
(86) PCT No.: PCT/GB04/02893

§ 371 Date: Feb. 23, 2006

(30) Foreign Application Priority Data
Jul. 7, 2003 (GB) 03158615

(51) Int. Cl. G07F 11/00

(52) U.S. Cl. 221/9

(57) ABSTRACT

The present invention relates to novel formulations, dosage forms and modes of delivery for treating patients addicted to a group of drugs which can result in dependence and misuse. The most serious drugs of addiction are cocaine, diamorphine (heroin), morphine and the synthetic opioids.

### FIELD OF THE INVENTION

The present invention relates to novel formulations, dosage forms and modes of delivery for treating patients addicted to a group of drugs which can result in dependence and misuse. The most serious drugs of addiction are cocaine, diamorphine (heroin), morphine and the synthetic opioids.

### BACKGROUND DESCRIPTION

The Misuse of Drugs Act 1971 prohibits certain activities in relation to “controlled drugs”.

Controlled drugs are placed in one of three class categories:

Class A includes: alfentanil, cocaine, dextromoramide, diamorphine (heroin), dipipanone, lysergide (LSD), methadone, methylenedioxymethamfetamine (MDMA, “ecstasy”), morphine, opium, pethidine, phencyclidine and class B substances when prepared for injection;

Class B includes: oral amphetamines, barbiturates, cannabis, cannabis resin, codeine, ethylmorphine, glutethimide, pentazocine, phenmetrazine and pholcodine; and

Class C includes: certain drugs related to amphetamines such as benzfetamine and chlorphentermine, buprenorphine, diethylpropion, mazindol, meprobamate, pemoline, pipradrol, most benzodiazepines, androgenic acid and anabolic steroids, clenbuterol, chorionic gonadotrophin (HCG), non human chorionic gonadotrophin, somatotropin, somatrem and somatropin.

The misuse of Drugs Regulations 1985 classifies the drugs in 5 Schedules

Schedule 1 includes drugs which are not used medicinally;

Schedule 2 includes the main drugs of abuse and includes drugs such as, diamorphine (heroin), morphine, pethidine, secobarbital, glutethimide, amphetamine and cocaine all of which, with the exception of secobarbita, are subject to the full controlled drug requirements; and

Schedule 3, 4 and 5 drugs have lesser controls.

The opioid drugs (which term includes not only drugs related chemically to morphine but also non-related structures which act at the same receptors in the brain) are used primarily to alleviate pain. These include many of the controlled drugs listed in the 1971 Misuse of Drugs Act and other drugs, including fentanyl. The term “opioid drug” does not, however, extend to cannabis since the cannabanoids act at a different receptor in the brain. In addition, cannabis is widely recognised not to be a drug of abuse despite its inclusion in Class B. In the context of the present invention, therefore, the term “drug of abuse” is to be understood to exclude cannabis. Some of the CNS mechanisms that reduce the perception of pain also produce euphoria, and opioid drugs may be taken for non-medicinal purposes in order to obtain the effect on mood. This gives the potential for abuse. Dependence to opioid drugs arises from repeated administration of opioid and is characterised by an overwhelming need to continue taking the drug or one with similar properties. Users develop a tendency to increase the dose owing to development of tolerance, and may develop a psychological and physical dependence on the drug. Cross-tolerance and cross-dependence exists between opioids acting at the same receptors. Opioid analgesics, particularly diamorphine, are abused for their euphoric effects and dependence develops rapidly with regular use.

Heroin (diamorphine) is an opioid drug that is abused widely. Street heroin (or “brown heroin), which is mainly crude heroin base, is widely available on the illicit market and is typically provided in 100 mg bags which are diluted (cut) so that each bag contains 4-10 mg of diamorphine hydrochloride, with the remainder being made up of soluble, inert diluents/adulterants. It is intended for injection as a solution extemporaneously prepared. Supplies containing a high proportion of heroin may be administered nasally (snorted), or smoked in reefers, as an alternative to intravenous injection. Diamorphine can also be heated to produce vapour which is inhaled via the respiratory tract (‘chasing the dragon’). It is estimated (on the basis of the number of heroin addicts arrested) that there are between 100,000 to one million addicts in the USA.

Injection of a heroin solution produces a variety of sensations described as warmth, taste, or high and intense pleasure (‘rush’). Heroin has high lipid solubility and crosses the blood brain barrier quickly. There it is deacylated to active metabolites including 6-monoacetyl morphine and morphine. After intense euphoria, which lasts from 45 seconds to several minutes, there is a period of sedation and tranquillity (‘on the nod’) lasting up to one hour. Effects wear off in 3-5 hours depending on dose, and the usual pattern of use is 24 injections per day. The heroin addict oscillates between feeling high, and experiencing the dysphoria of early withdrawal. This oscillation produces a number of problems in homeostatic systems, which may also interact with endogenous opioids.

With diamorphine, withdrawal symptoms usually begin within a few hours, reach a peak within 36-72 hours and then gradually subside.

Diamorphine abuse is a major problem; however dependence in patients who are receiving diamorphine for the relief of pain is much less prevalent.

Methadone is a synthetic opioid, which is used as an analgesic and cough suppressant and as an alternative to diamorphine for treating diamorphine addicts. It is well absorbed orally, and when given to patients who are addicted to other opioids produces less acute oscillations between the high and early withdrawal. Withdrawal may develop more slowly with methadone than diamorphine. However, there is a tendency amongst drug addicts to inject in order to obtain a quicker and more intense high.

Opioids themselves, such as methadone, are also used in the management of other opioid, particularly heroin, dependency. The usual method in the UK is to replace the diamorphine with methadone, which is given as a liquid oral preparation, which is then gradually withdrawn over a period of time. In other countries, other opioids such as buprenorphine may be used in, e.g. sublingual tablets or nasal spray form. Methadone is useful for withdrawal therapy because it can be given orally and its long half-life allows once-daily administration. Liquid oral preparations are usually preferred, but in withdrawal programmes it is usual for patients to attend pharmacies, or other treatment centres where the prescribed dose is given under supervision.

Other opioids which have been used successfully with addicts include dihydrocodeine tablets, levomethadyl acetate (similar to methadone, but with an extremely long half-life), and buprenorphene given sublingually.

Methadone is generally available as a 1 mg/ml mixture and is usually given in doses of 30-60 ml per day.

The Drug Tariff Formula (DTF) of methadone is a solution of methadone hydrochloride in an aqueous solution of hydrogenated glucose syrup (Maltitol). It has a bitter taste, and this determines the volume and concentration which can be given at one time.

The prescribing of diamorphine (heroin), dipipanone and cocaine for addicts are controlled by The misuse of Drugs (supply to addicts) Regulations 1977 which require that only medical practitioners who hold a special license issued by the United Kingdom Home Office may prescribe, administer or supply these drugs in the treatment of drug addiction. Prescriptions for weekly supplies are sent to the pharmacy weekly and must be dispensed on a daily basis by the doctor, typically for oral administration.

This strategy is intended to ensure that such drugs are not misused. However the regime is expensive to run as a doctor has to be available daily to dispense the drugs and it is inconvenient for patients who have to travel to the doctor each day.

Access under close professional supervision to controlled doses of controlled drugs or drugs of abuse such as, for example, diamorphine and methadone (which is often used as a diamorphine substitute in the treatment of diamorphine addicts) has a place in the treatment of drug abuse. Problems associated with the current treatment of, in particular, diamorphine addicts include:
Illicit supplies of heroin are of variable quantity and some may pose health hazards;
Intravenous (iv) administration of heroin by injection opens up the possibility of infection and disease transmission through needle sharing or more seriously, death by overdose; and
Whilst supervised administration of defined doses of diamorphine is a recognised strategy it requires input of healthcare professionals, time and counselling to be effective.

In order to address the problems highlighted above, it is desireable to find non-invasive methods of administration in order to try to avoid or minimise the problems resultant from i.v. administration. In order for the treatment regimens to be effective, patients require access to sufficient doses of material. These doses, however, need to be difficult to divert per se, i.e. without achieving this end solely by the close supervision by health professionals. In other words, an aim of the present invention was to identify alternative ways of delivering controlled drugs or drugs of abuse to patients in an effective and safe manner.

Ideally, formulations in treatment regimens need to be presented in convenient formats, preferably with facilities available for recording dates and/or times of usage so as to control dosages administered remotely, i.e. without requiring the supervision of health professionals at the time of administration.

Since formulations of controlled drugs and/or drugs of abuse as defined herein, and in particular Classes A-C especially Class A and B and particularly Class A and/or Schedule 2 drugs such drugs must be administered by health professionals, there is no strict need at present to prevent diversion or to monitor dosing regimens since these issues do not arise. However, the Applicant's invention addresses the scenario where it is desired to administer such drugs in the absence of a health professional by providing formulations and apparatus for the controlled administration of these formulations in the absence of health professionals.

According to a first aspect of the present invention there is provided a dispenser comprising a reservoir containing a plurality of dosage units each of which comprises a controlled drug or a drug of abuse, said dosage units being contained in a tamper-evident manner such that access to the dosage units in use is controlled either by the dispenser or remotely and/or is monitored either by the dispenser or remotely.

According to a second aspect of the invention, there is provided a reservoir containing a plurality of dosage units each of which comprises a controlled drug or a drug of abuse for the use with the dispenser according to the first aspect of the invention.

The reservoir may take the form of a container within which liquid or solid formulations are held; or an indexed system means which allow access to capsules or dry formulations sequentially. Examples of suitable reservoirs are discussed in greater detail hereinafter.

According to a third aspect the present invention, there is provided a method of making the dispenser according to the first aspect of the invention comprising introducing the plurality of dosage units into the reservoir and then sealing the reservoir in the dispenser so as to render the dispenser tamper-evident.

The dispenser of the invention is useful in order to be able to provide access to controlled drugs or drugs of abuse, in a restricted manner, and in such a way that a clinician need not be present at the administration.

By controlling remotely is meant that control over access to the dosage units may be achieved in the absence of a doctor or other medical practitioner. This may be effected by preprogramming of the dispenser, for example, such that the doctor or other medical practitioner need not be present in order to control the access: the control is thus in accordance with his instructions, e.g. by way of a prescription.

Monitoring is by the dispenser itself for extemporaneous monitoring by or on behalf of medical practitioner; or remotely, e.g. by way of transmittal of the fact a dosage unit has been administered to a computer at a remote location. It will be understood that control is ultimately under the direction of a doctor or other medical practitioner whereas monitoring need not be by a doctor or other medical practitioner.

Viewed from a further aspect, therefore, the invention provides a controlled method of talking a drug of abuse or a controlled drug comprising administering said drug of abuse or controlled drug from a dispenser according to the first aspect of the invention.

Administration may be but need not be by a patient in the absence of a medical practitioner, i.e. may be self-administration.

Viewed from a still further aspect, the invention provides the use of a drug of abuse or a controlled drug, or of a formulation of such a drug according to the invention, in the manufacture of a medicament for use in a controlled method of taking a drug of abuse or a controlled drug comprising administering said drug of abuse or controlled drug from a dispenser according to the first aspect of the invention.

In order to be used in the dispenser according to the first aspect of the invention recited, the drugs need to be formulated and packaged in a manner that permits dispensation.

The invention also provides a vapourisable diamorphine formulation comprising one or a plurality of unit dosages of diamorphine on one or more heatable surfaces.

The invention also provides a diamorphine formulation comprising a solubility enhancer.

The novel formulations described herein may be used as medicaments, particularly in the treatment of drug abuse and/or drug addiction.

Certain aspects of this invention may be understood by way of example with reference to the accompanying drawings in which:

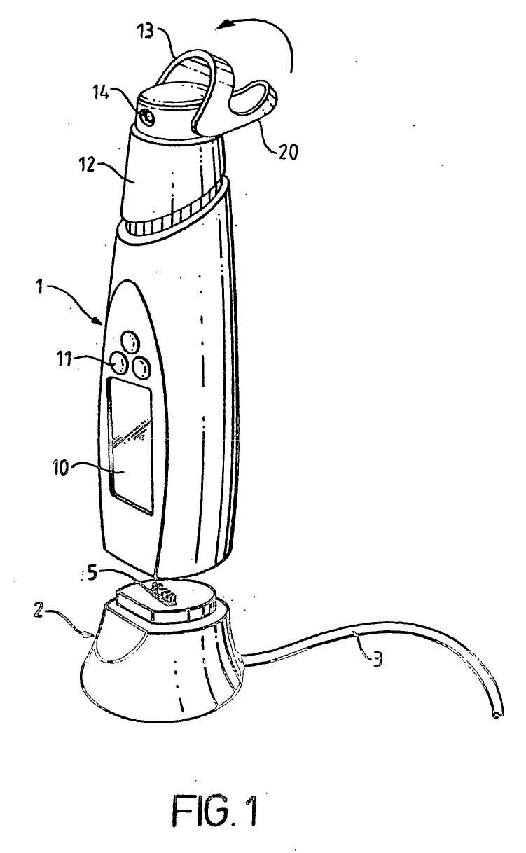

FIG. 1 shows a drug dispensing unit and base station in accordance with the present invention;

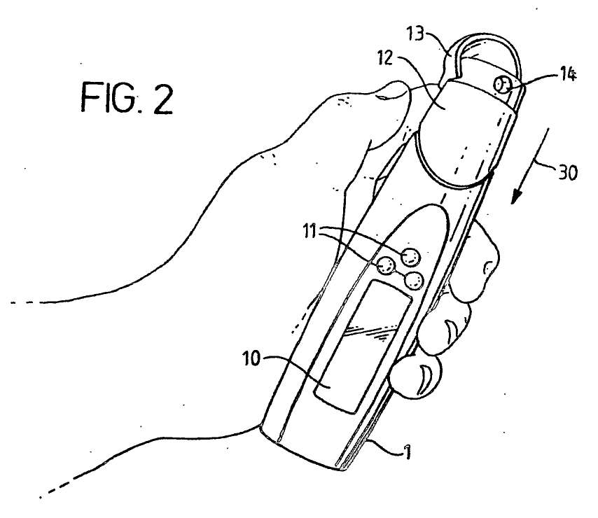

FIG. 2 shows the unit of FIG. 1 about to be used;

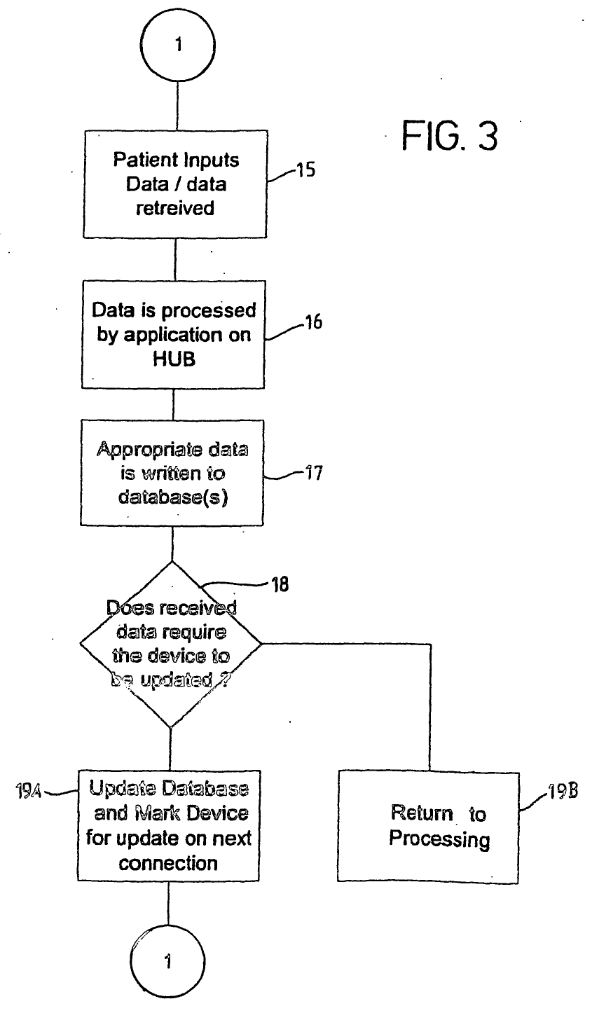

FIG. 3 is a flow diagram of one aspect of the operating system;

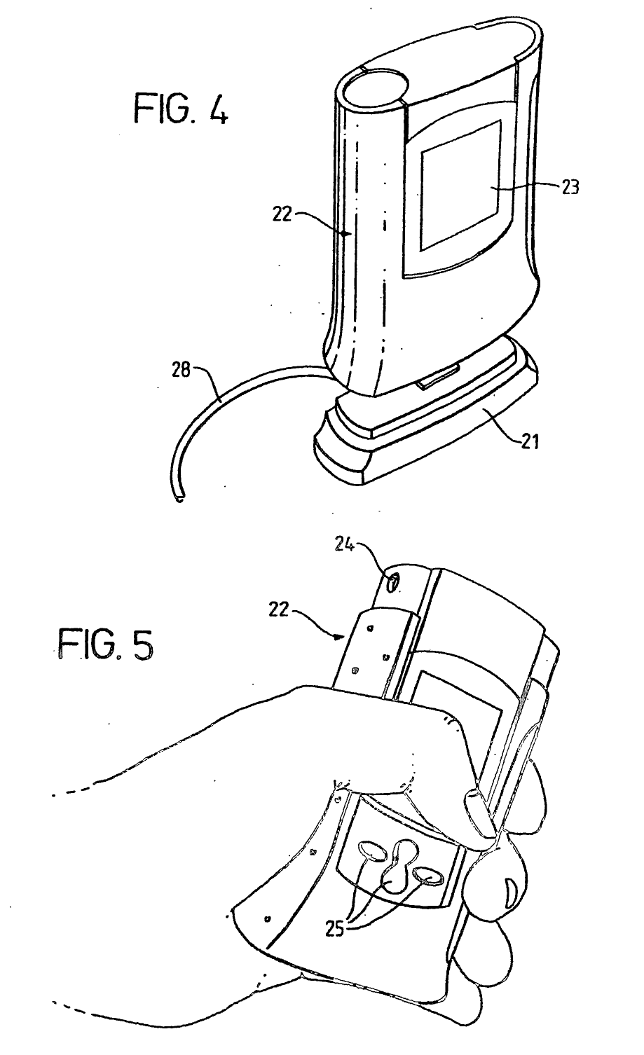

FIG. 4 shows an alternative general view of an alternative dispensing unit and base station;

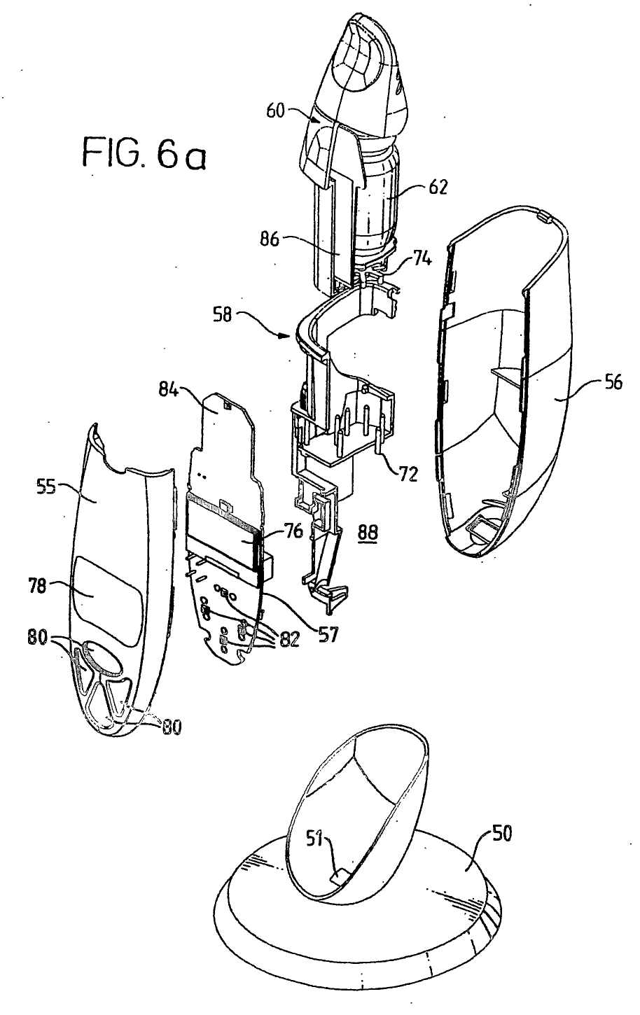

FIG. 5 shows the unit of FIG. 4 in use;

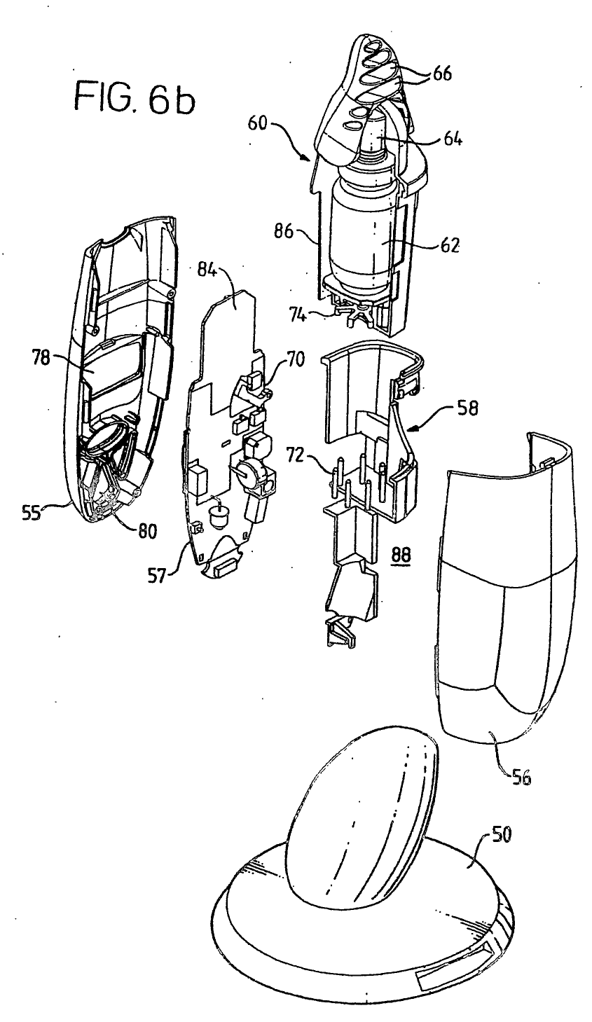

FIGS. 6a and 6b show in exploded view from front and back respectively a third embodiment of a drug-dispensing unit and base station in accordance with the invention; and

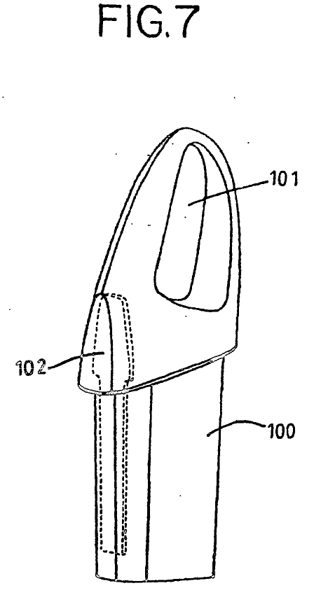

FIG. 7 is a perspective view of a cartridge for insertion into the dispenser previously described.

The present invention provides dispensers which enable the access to controlled drugs or drugs of abuse therein to be regulated. The form of regulation takes the form of strict controls; these controls include controlling the dose delivered and/or the timings of the doses. The dose and/or timing controls may allow for self-titration within set limits. For example, addicts presenting themselves for treatment at the beginning may need to self-titrate to determine what level of pharmaceutical dosage is required to meet their needs. Thereafter, control is strict and controlled by a doctor or other medical practitioner.

Preferably the dispenser also contains a facility that permits recordal of the fact that a dose has been presented and furthermore allows this to be communicated to e.g. the doctor and/or pharmacist so that compliance can be monitored and the presentation regime modified if appropriate. Rf tags provide a particularly beneficial way of allowing 2-way communication to and from a device capable of presenting a controlled drug or drug of abuse to the patient.

The dispensers are tamper-evident as opposed to tamper-proof, that is if attempts are made to tamper with the dispensers, i.e. if they are used or are attempted to be used not in accordance with any prescribed controls, this will be detectable. Additionally or alternatively, any tampering with the dispensers may be monitored, either remotely or upon inspection of the dispenser, e.g. when refilling with further dosage units after consumption of the dosage units with which they were filled previously.

The dispenser may be integral with the reservoir. In this way, the external casing of the reservoir provides the restriction in access required by the first aspect of the invention. Generally, however, the reservoir is for use with a dispenser and without which the contents of the reservoir may not be accessed (without breaking into the reservoir for example).

A preferred embodiment of the various aspects of the invention comprises containing the controlled drug or drug of abuse in a dispensing device or dispensing system which provides the necessary control over patient access to the controlled drug or drug of abuse. Suitable dispensing devices include those described in GB2368061 and GB2368098, further improvements of which are described in GB2391857. Such devices or dispensing systems generally comprise a dispenser, a locking mechanism on the dispenser to prevent dispensing of the material, a user interface allowing the user to input data, and a control device remote from the dispenser, the control device being arranged to receive the input data and to enable release of the locking mechanism to allow dispensing of the material.

One particularly preferred such device will now be described although it will of course be apparent that the invention may be effected with alternative dispensers.

Referring to the drawings, FIG. 1 shows a dispensing unit generally denoted 1 which can be placed on top of a base unit generally denoted 2. The base unit is connected via a power and signal cable 3 with appropriate related apparatus, for example to a telephone socket or to a PC interface card. The upper face of the docking station 2 carries a row of connector terminals 5 which can, when the dispensing unit 1 is placed on the docking station, electrically contact corresponding members (not shown in FIGS. 1 and 2) located on the underside of the dispensing unit 1.

The dispensing unit itself is provided with a liquid crystal display screen 10 and some function buttons 11, and has at its upper end a nozzle actuation cap 12 with a lowerable closure tab 13 which can be used to cover an aerosol outlet 14 in cap 12, thus preventing the aerosol outlet being clogged with dust, dirt or other contamination.

Cap 12 may be releasable from the upper end of the main body of the dispensing device as shown in the drawings to enable a canister with a standardised outlet tube to be located within it, the outlet tube being registered with an appropriate aerosol nozzle 14. By pressing the cap 12 down into the main body of dispensing device 1, the aerosol valve may be actuated and a dose of material expelled, whereafter an electromechanical latch within the main body of the dispensing device 1 may act to prevent the cap 12 being pushed into the body of dispensing device 1 a second time until release occurs. Release may occur merely following the passing of a given period of time, but it is highly desirable more positively to control the ability of the device to dispense. For this purpose, it is straightforward to arrange that the latch within the main body of dispensing device 1 will remain locked to prevent a further depression of cap 12 until appropriate steps are taken to release it. For example, release may be affected remotely in accordance with a programmed regime by placing the dispensing unit 1 on to the base station 2 and thereafter having the dispensing station and the base station communicate with one another, whereon, if appropriate, the internal latching may be released. The status of the dispensing device may be shown on screen 10, both before and after placing on the base station. A number of push buttons 11 are provided in order to control input from the user, for example to enable the user to set up a communication link with the remote computer via the base station 2.

Once such a link had been established and e.g. the latch released so that a second dose may be dispensed, the dispensing device 1 may be removed from the base station, held in the hand as shown in FIG. 2, and the cap again depressed in the direction of arrow 30 shown on FIG. 2. It is easy to arrange that when such actuation occurs, the latch within the dispensing unit 1 re-engages to prevent a second dispensing action and, separately, the status of the dispensing unit may change, the change being displayed in window 10.

Alternatively, the device may include control circuitry internally, such circuitry acting to release locking and enable a further dose to be dispensed after a suitable period of time, and preferably including a rewritable memory store to maintain a record of when doses were in fact administered and when and how the device was interacted with by the user. The content of such a store may be automatically transferred to a store in the docking station when the device is docked, or transferred direct to a remote computer if desired.

It is often desirable to record additional information from a patient, for example as to their general state of well being and the effect that the medication has had on them. This can be a useful diagnostic tool for medical practitioners, and is particularly useful in the case of clinical trials. The device therefore includes a means for inputting this information. In its simplest form, this could take the form of a set of questions being displayed on the LCD screen 10 with a set of multiple choice answers which the user selects using function buttons 11. The function buttons 11 could also be used to input text. However, this is likely to be time consuming, and if text input is required, some further device such as lap top computer, PDA, or communications device can be connected to the base station 2 either physically or remotely. Alternatively the communications devices and input devices could have their own link to the remote computer alleviating the need to connect the base station 2. Alternatively, for patients having difficulty with their manual dexterity, the input device could be a microphone to record the necessary information orally. This can then be converted to text using voice recognition software either locally, or at the remoter computer. Alternatively, the text could be typed manually.

In order to ensure patient compliance with the requirements to enter this text, the remote computer is set so as not to release the latch until the information has been recorded, processed and a determination as to what course of action should be taken with respect to the locking or unlocking of the latch has been made from the recorded information and/or the other data from the remote system.

FIG. 3 illustrates the operation of this aspect of the invention. The patient inputs data through device 1, or some other device as described above as step 15. This data is transmitted to a remote hub providing a control device where it is processed as step 16 and appropriate data is written to a database at step 17. At step 18, the hub determines whether the received data necessitates any updating of the device. The system has a set of rules that will be used to determine whether or not to update data within the dispenser which will in turn influence the operation of the blocking mechanism. Thus, if the hub determines that the necessary data has been correctly received and derives from the data that the device needs to be updated or the locking mechanism state should be altered, it will update the device at step 19A and will then return to processing at step 19B.

Although this process has been described in relation to additional data input by the user, it is also applicable to information received directly from the device itself relating to the patient usage data. Thus, for example, the hub can be programmed to recognise certain unusual dosage patterns and to alert a medical practitioner, to adjust the dosage regime, or to lock the device to prevent further usage.

If, for example, a patient has a dosage regime of one tablet of a drug three times a day, and the control protocol requires that a patient complete a data entry in an electronic diary before the next dose can be taken, the system will automatically restrict the dose until the diary is completed. An alert can be sent if the dose is not taken or the diary is not completed within a prescribed period. This can give a clinical trial investigator real time information about the dosing/data recording behaviour of the patient group.

The benefit of this device is that the input data is clean at source, as it must be entered before the next dose can be dispensed. The system can also be configured to accept data after the drug has been dispensed.

As shown in FIG. 1, the closure tab 13 which acts to shield ingress of dirt into the dispensing outlet 14 has an angled out portion 20 which can be engaged by the forefinger of the left hand as shown in FIG. 2 of the drawings in order to achieve dispensing.

Such an approach is not always desirable, or, indeed, convenient, and it may be particularly awkward for people with arthritis. Accordingly, FIGS. 4 and 5 show an alternative construction where dispensing is achieved by means of a lateral grip across a generally oval cross-section elongate housing which covers the dispensing device.

Located within the housings of the respective dispensing devices 1 and 22 shown in FIGS. 1 and 4 respectively are also appropriate electronics and a power supply or back-up power supply, for example one or more battery cells. Of desired, the electronics may be rechargeable and recharging can take place when the respective dispensing unit is located on its docking station 2 or 21. This can obviously be effected automatically by appropriate design and programming.

FIGS. 6a and 6b show a further embodiment of the dispensing system, in each case in exploded view from front and back respectively. Referring to these figures, from which detail has been omitted for the sake of clarity, the system consists of a base station 50 into which a hand-held dispenser can be set when needed. A contact pad 51 enables signals to be sent to and from the hand-held unit when it is placed in base station 50.

The hand-held unit consists basically of front and rear casing shells 55, 56 respectively which clip together round a circuit board 57 and an internal moulded receptacle unit 58. Shown above unit 58 in the drawing is a removable cartridge housing 60 which may be locked into place in the assembled housing or released therefrom as and when necessary. Cartridge housing 60 is designed to receive a container of medicament 62, here in the form of an aerosol spray canister with a dispensing nozzle 64 which lies in the upper part of housing 60 having a number of weight reducing indentations 66, and which is suitably configured to enable a dose of medicament to be dispensed sub-lingually via apertures (not shown).

Circuit board 57 bears a latch assembly 70 designed to interact with portions of housing 60 to enable the housing to be latched in place or removed upwardly from the rest of the device. The latching assembly also allows, at appropriate intervals controlled by programming, the housing 60 to be pushed down in the upper half of moulding 58 to enable a set of pins 72 to press on the ends of the arms of a spider 74 and so cause the container 62 to be pressed towards the nozzle 64, so dispensing a dose of medicament therefrom. After one (or if programmed appropriately more) such compressions, the latch assembly may lock the housing 60 against further such movement until released when the next dose of medicament is due to be dispensed. The exact nature of the operation of the spider 74 and associated components is described in more detail in GB2368098.

Circuit board 57 carries a display screen 76 visible through a window 78 in casing front 55. In use of the device, this screen can carry a message to the user, for example indicating the state of the device, ready to dispense or locked. Casing front 55 also has four apertures 80 which, when the device is assembled, are filled with rubbery press buttons (not shown in the drawing), which enable actuation of four switches 82 set in circuit board 57. The upper end 84 of board 57 carries a printed RF antenna which enables the checking of a so-called RF tag 86 which forms part of the cartridge assembly. This enables the system to check just what medicament has been loaded into it when a fresh container 62 and associated tag 86 are inserted into the upper housing 60 and that housing latched into position in moulding 58.

The hand-held unit may be powered by a suitable battery which can fit in the area denoted 88 in the drawing.

It will be readily appreciated that using devices as shown in FIGS. 1, 5, and 6a/6b, the degree of control of dosage can be very high and the ease of recording and monitoring of the dosage regime is substantial. If, for example, the base station 2, 21 or 50 is connected into the normal telephone system, a central controlling computer can monitor the operation of the device by the user remotely, and any anomalous or undesired administration can be detected rapidly and appropriate immediate action taken. A further advantage is that, for example, a sounder is easily incorporated into the base unit which can be programmed by the central computer to emit an audible signal, e.g. to remind a user that dosage is overdue. The operating rules may provide that if within say 5 minutes of the emission of such an audible signal the user does not acknowledge having heard it, an appropriate record can be made of this event.

As noted above, the device itself may include appropriate control circuitry including a memory device. In such a case, it is possible to programme that circuitry (and a remote computer) so that when the device is first docked, it starts by establishing a communication link with the remote computer, which can then initially set-up the device with appropriate parameters for a patient. These could, for example, govern the length of a PIN No required to access the docking station and details of the proposed dosage regime, for example initially loading an expected running average based on the prior doctor/patient experience. This false average could form the foundation for a continuing running average that is calculated with time and use. This data would constitute a benchmark, enabling the device thereafter to monitor usage levels and to detect any incidence of deviation. The time and frequency of use, and other events such as opening of the casing or tampering with it, may be stored and uploaded to a central system as desired. The system may be programmed to issue restrictive orders on the patient's medication, or it may simply be programmed to report data, so as to highlight areas of concern and alert the appropriate GP or specialist for attention at the patient's next appointment.

As noted above with reference to FIGS. 6a/6b, in place of or supplementary to the downloading of data via a remote link, data may be stored with the container for the material to be dispensed. In some areas, there is already a requirement for a form of tagging on medicinal canisters that can be read or written to. This tag carries information as to the medication type, use-by dates, etc. and when used with a device according to the present invention, the tag may be accessed by the device (and/or via the docking station), and the device could be programmed to write to the tag the number of doses left in case of removal from the device. The tag could have a large memory capacity free for other uses. On return of the canister to the pharmacist, the usage data written to the canister can then be interrogated. Data as to when the canister was used and by whom, would remain with the canister of medication that was dispensed. This method of data management may prove to be more convenient and effective in some cases than online monitoring with the device (including the canister) being mated with the docking station.

The device may be used to dispense medication at fixed times throughout the day. Alternatively, it can be programmed in a “free dosing” mode. The device itself, of the medicinal canister can be programmed to set the free dosing mode, i.e. to allow the user to dose freely during a predefined period until a maximum allowable number of doses is reached.

In certain circumstances, it may be desirable to programme the medicinal canister to a free dosing mode, but to allow the device to override this mode, thereby allowing, for example, the free dosing mode to be manually overridden by a doctor from a remote location. The device or medicinal canister can be programmed with different dispensing regimes for different days of the week, thereby varying the daily dosage.

It can be seen that a wide variety of modifications may be made to the overall construction and design described above, many of them easily made simply by changing computer programmes. Such changes could be made “online” when the hand-held unit is in the docking or base station and in communication with a host computer. The system is of particular value in the monitoring and analysis of administration during a controlled trial, enabling it to be highly automated and reliable. In particular, detection of activity outside the instructions or constraints of the trial can be immediately and automatically achieved.

In addition to or instead of configuring the device remotely from the computer via a communication link, an alternative means configuration will now be described with reference to FIG. 7. This discloses a cartridge 100 designed to fit in a dispenser of FIGS. 6a and 6b. Similar arrangements using appropriately shaped cartridges may be employed with the examples of the previous figures. The lower half of the cartridge 100 is shaped in the same way as the housing 60 so as to fit into the same socket in the dispenser. The upper part of the cartridge 100 may be shaped in any way, and in this case has an aperture 101 for ease of removal. The cartridge 100 contains no medication, but has a RF tag 102 sized and positioned similarly to RF tag 86. This tag 102 contains the patient specific information used to configure the device.

If cartridge 100 is configured for a particular device and is subsequently inserted into that device, only that device will be configured. If however the same cartridge is inserted into another device that the cartridge has not been configured for, the cartridge will not authorise that dispense device. It will however cause the device that it was inserted into to log the serial number of the cartridge in its memory. When the unauthorised dispensing device is next downloaded it will become apparent that the cartridge has been inserted into the device.

If however a user has a number of dispense devices, say one in the home another in the car and a further device in the office, the cartridge 100 could be configured to authenticate and configure all devices upon insertion of the cartridge into the relevant device.

When patients use the device they will have to enter their security PIN code to access the drugs. On occasions the patient may forget the PIN code. In this event the user can insert the cartridge into the device which will replay the PIN by way of flashing the appropriate buttons and prompting the user to confirm by way of pressing the button indicated.

In order to provide the ability to prevent the dispenser from dispensing when it is not an authorised location, a number of approaches may be adopted.

Most simply, the dispensing unit 1 and base unit 2 of the example of FIG. 1 may be provided with an RF transmission mechanism. Signals received by the base unit 2 from the dispenser 1 are analysed by the control circuitry to determine whether or not the dispensing unit 1 is within an authorised radius of the docking station. If so, the control circuitry will release the locking mechanism. If not, the locking mechanism will remain in place. Similar considerations apply to the example of FIGS. 6a and 6b, where the distance from the base station 50 can be monitored.

The dispensing at an authorised location may be used in combination with other pre-programmed parameters referred to above, such as dosage patterns etc. A user will therefore only be able to access the drugs when at an authorised location and when it is time to dispense the dose in accordance with other pre-programmed parameters.

Alternatively, the location of the dispenser may be monitored using global positioning (GPS), cellular positioning (CPS) or a triangulation system.

As noted above, drugs need to be formulated and packaged in manners that avail themselves to dispensing via dispensers and in uses and methods according to the present invention. The preferred formulations of controlled drugs/drugs of abuse which are suitable for use in accordance with the invention, and which themselves form a further aspect of the invention will now be described in detail.

These formulations of the invention are suitable for containment in the dispensers of the invention, in particular those preferred dispensers described in GB2368061 and GB2368098, further improvements of which are described in GB2391857.

The formulations preferably contain more than 1 day's supply, e.g. requirement, of drug and preferably provide 1 week's (or more) supply in solid or liquid dosage formulations, for example, liquid formulations.

Where the formulations are liquids or dry powders the reservoirs may be canisters, for example, or glass or plastic bottles held within the dispensers.

The formulations of the invention most useful in alleviating pressure on medical practitioners comprise diamorphine and the remaining discussion will focus on these exemplary controlled drugs or drugs of abuse although it will be understood that the invention is not limited to these particular drugs and additionally include without limitation methadone, buprenorphine, fentanyl and morphine.

The drugs utilised according to the various aspects of the invention are substantially pure and are thus suitable for incorporation into medicaments. By substantially pure is meant a purity of more than 95%, preferably more than 98% and still more preferably more than 99%. The formulations too are preferably substantially pure, in other words, the components added constitute at least 95%, preferably at least 98% and more preferably 99.5% of the formulations.

Preferably, according to the methods of taking the drugs of the invention, the concentration of drug in the formulations is gradually reduced as the treatment regime proceeds. Thus, whilst the initial concentration might be, e.g. 50 mg/ml in the formulations, this may be reduced to 40 mg/ml then 30 mg/ml and so on until the addict no longer obtains a physiological effect from the formulation.

Diamorphine as used herein should be understood in the absence of indication to the contrary to embrace diamorphine base as well as their pharmaceutically acceptable salts, e.g. diamorphine hydrochloride.

The diamorphine formulations developed by the applicant which are suitable for use with the dispensers and methods of the invention will now be described. These are pharmaceutical compositions suitable for use in a secure delivery device such as the dispensers described herein and which mimic the effects that addicts seek through typical “street use” methods.

Where diamorphine formulations are provided on a heatable surface, there is preferably provided 5-50 mg of methadone hydrochloride, e.g. 10-40 mg in each dosage unit.

Preferably the heatable surface is an electroresistive surface preferably provided with electrical contacts so as to permit electrical heating. One such surface is a resistive element, for example of the type described in WO 03/037412.

Surprisingly, it has been found that if the diamorphine hydrochloride is admixed in the dry state with an amount of a non-volatile alkaline substance, preferably in an amount up to and including that sufficient to neutralise the hydrochloride salt, particularly in an amount sufficient to neutralise the hydrochloride salt, the resulting mixture is stable. On heating, reaction between the alkali and diamorphine hydrochloride produces volatile diamorphine base which can be vaporised.

The diamorphine hydrochloride present in such formulations is present generally in the amounts given above, i.e. 5-50 mg of methadone hydrochloride, e.g. 10-40 mgs. Expressed as a % w/w of the formulation as a whole (before drying) these quantities are 5-50% w/w, and 10-40% w/w.

Preferred alkaline substances include metal bicarbonates and carbonates, for example, sodium carbonate and sodium bicarbonate, sodium bicarbonate being preferred. The alkaline substances is preferably present in an amount of 0.5-10% w/w, all percentages being given on the basis of the weight of the compositions as a whole (before drying). Preferred quantities of sodium bicarbonate are 1-10% w/w (appropriate to neutralise 5-50% w/w of diamorphine hydrochloride) e.g. 2-8% w/w (appropriate to neutralise 10-40% w/w of diamorphine hydrochloride).

In a preferred embodiment the compositions may further comprise one or more hydrated salts which on heating release water of crystallisation and thereby modify the humidity and temperature of the vapour produced from the composition; improves patient acceptability.

Preferred hydrated salts are pharmaceutically acceptable salts of metals in group 1 or 2 of the periodic table which are solids, but yield water of crystallisation when heated. This release of water of crystallisation has the effect of extracting latent heat and thereby reducing the temperature of vaporisation. In addition, release of water of crystallisation humidifies the vapour produced by heating the composition.

The small quantity of water vapour generated facilitates the reaction between the alkaline substance and the alkaloidal salt. Since water withdraws latent heat during vaporisation this results in better control of the operating temperature, and also increases the humidity of the vapour so generated.

The metal salt may be added in a hydrated form. Examples of such hydrates are calcium sulfate dihydrate, sodium phosphate dodecacahydrate and sodium carbonate dec-ahydrate. Alternatively the inorganic salt may be anhydrous. An example of an appropriate anhydrous salt is sodium sulfate. When formulated in water and allowed to dry, water of crystallisation is formed (e.g. to produce sodium sulfate docecahydrate). It will be appreciated that mixtures of salts may be added. Typical quantities of salts are present in an amount of from 2.5 to 25% w/w.

Other preferred ingredients include binding agents, e.g. povidine. Binding agents are preferably present in an amount of from 0.5-5% w/w.

In a preferred embodiment the compositions according to the invention may comprise one or more inert, non-combustible carriers or solvents, in addition to the therapeutic substances. Preferred inert, non-combustible carrier substances include diatomaceous earth compounds, clays, silicates, carbonates, sulphites or sulphates of mono-dibasic metals or a mixtures thereof. Bentonite is a preferred example. Preferred solvents include ethanol, as it will evaporate off.

Preferred amounts of the inert, non-combustible carrier substances, e.g. bentonite, are 1-10% w/v. Aqueous alcohol (e.g. about 50% v/v) may be added to achieve the mass balance. Generally the required dry ingredients are powdered and mixed before addition of sufficient solvent, e.g. water or aqueous alcohol, to form a smooth paste which may be applied to the heatable surface. The formulation is then dried ready for vapourisation. Such formulations are particularly suitable for dispensing in the dispensers described herein.

Diamorphine can also be formulated with a solubility enhancer for use as a nasal spray (a delivery route comparable to snorting). Such formulations are administered as liquids and preferably comprise 10 to 50% w/v, e.g. 20 to 40% w/v diamorphine or diamorphine hydrochloride. Preferably one or more solubility enhancers are present in an amount of 1 to 10% w/v, preferably of 4 to 8% w/v. Such formulations are also readily transferable to the tamper-evident dispensers as described herein.

Preferably the solubility enhancer comprises one or more of caffeine, sodium benzoate and sodium salicylate. Preferably the solubility enhancer is or comprises caffeine. Preferably the caffeine is present with sodium benzoate and/or sodium salicylate.

The formulation of diamorphine for nasal sprays are initially formulated as dry mixtures since diamorphine is insufficiently stable in aqueous solution to be supplied as such. Prior to use the dry mixture may be dissolved in an aqueous solution. This may be water or a dilute, e.g. around 0.5-1.5 wt % preferably about 0.9 wt %, sodium chloride solution. It is not necessary to use solvents other than water, however, since 10% w/v solutions of diamorphine are approximately iso-osmatic with blood and are thus suitable for nasal administration.

The caffeine and diamorphine make only a small contribution to osmolarity; sodium benzoate also contributes to the osmolarity and the reconstituted solution is approximately iso-osmotic with nasal secretion. Sodium salicylate also solubilises caffeine and diamorphine and can be used interchangeably with sodium benzoate. Caffeine has been shown to increase the solubility of diamorphine hydrochloride and the combination of caffeine and sodium benzoate is pharmaceutically acceptable. Equal quantities of (i) caffeine and (ii) sodium benzoate or sodium salicylate or mixture of sodium benzoate and sodium salicylate are preferably used to make the pharmacopoeial preparation

Surprisingly, sodium benzoate is present in sufficient quantity acts as an antimicrobial preservative. The use of caffeine and sodium benzoate as solubiliser allows high concentrations of diamorphine to be contained in a solution.

The constituents of the formulations suitable for nasal administration are supplied in the dry state. This may be achieved, either by mixing appropriate proportions in the dry state and introducing them into a container; or by introducing a solution containing the ingredients, after sterile filtration, into the container, e.g. glass vial, and freeze-drying the mixture. An advantage of this technique is that the mixture can be reconstituted very quickly.

The containers used are preferably glass which is preferably coloured, e.g. amber. The containers are preferably of the correct dimensions for use in the dispensers described herein.

The container filled with the optionally lyophilised dry powder may be held within a cartridge held within the dispensers. When use is to be made of the dry formulation, water or other liquid (e.g. saline) may be introduced from a plastic ampoule, graduated syringe or other container which may contain the aqueous solution (e.g. water or saline) necessary to generate the aqueous formulation suitable for administration. The liquid necessary may be supplied with the dispenser containing the dry powder, or may be supplied separately. The former constitutes a still further aspect of the present invention. Viewed from this aspect there is provided a kit of parts comprising a dispenser comprising a dry formulation of diamorphine suitable for nasal delivery upon mixing with aqueous solution; and aqueous liquid for introduction into the dispenser for rendering the formulation suitable for nasal administration.

Preferably the aqueous liquid is sterile. Generally the aqueous liquid is water. An example of such a kit and its use may be described as follows:

A syringe containing aqueous solution is introduced into contact with the dry formulation within the dispenser by connecting the two and injecting the solution into the dispenser. Conveniently, this may be assisted by the container inside the dispenser in which the dry formulation held is under negative pressure. Removal of the syringe and exchange for a pumping unit to the container permits the dispenser to be operable. Preferably the glass container within which the powder is held is within a cartridge and cannot be tampered with without detection. Containment in this way assists in maintaining integrity of the package and acts as a deterrent to diversion.

If required, the reconstitution can be carried out by a health professional, under supervision. However, this may not be necessary, e.g. should the patient comply with the requirements of the treatment regime.

The provision of liquid dosage forms in the form of a cartridge allows for dispensing under controlled conditions as disclosed in the Advanced Dispensing System described in UK Patent Application numbers GB0025809.5 and GB0025811.1

The invention will now be described, by way of example only, with reference to some exemplary formulations of controlled drugs or drugs of abuse for use with the dispensers described herein.

### EXAMPLE 1

Diamorphine Formulations for Vapourisation

| CONSTITUENT | Weight in mg | | | | | |
|---|---|---|---|---|---|---|
| Diamorphine Hydrochloride | 10 | 10 | 20 | 20 | 40 | 40 |
| Sodium Bicarbonate | 1 | 2 | 2 | 4 | 4 | 8 |
| Sodium Sulphate (anhydrous) | 5 | 5 | 10 | 10 | 20 | 20 |
| Povidone | 1 | 1 | 2 | 2 | 4 | 4 |
| Bentonite | 2 | 2 | 4 | 4 | 8 | 8 |

| | |
|---|---|
| Aqueous Alcohol (50%) | to 100 mg |

The dry ingredients in the amounts specified in the table above are powdered and mixed. Sufficient aqueous alcohol is added to form a smooth paste. Portions are dispensed onto an electroresistive substrate (for example as described in GB 0126150.2) and allowed to dry. The substrate has provision for electrical contacts, which in use generate heat, which vaporises the dosage form. The anhydrous sodium sulphate in the formulation takes up water, as water of crystallisation, (to form the dodeca salt) and on heating sufficient water is generated to facilitate reaction between the bicarbonate and the diamorphine hydrochloride to form a diamorphine base. This is volatile and is vaporised. The free vapour is then inhaled into the respiratory tract. The provision of finished dosage forms in the form of a cartridge allows for dispensing under controlled conditions as envisaged in the Advanced Dispensing System described in UK Patent Application numbers GB0025809.5 and GB0025811.1

### EXAMPLE 2

Diamorphine Formulation for Nasal Delivery

A preparation for intranasal administration can be made as follows. The quantities given are sufficient to prepare a dispenser containing 100 dosage units each of which comprise either 10 or 20 mg of diamorphine hydrochloride.

| CONSTITUENT | A | B | C | D |
|---|---|---|---|---|
| Diamorphine Hydrochloride | 1 g | 2 g | 1 g | 2 g |
| Caffeine | 200 mg | 200 mg | 200 mg | 200 mg |
| Sodium Benzoate | 200 mg | 200 mg | — | — |
| Sodium Salicylate | — | — | 200 mg | 200 mg |
| Water (added prior to use) | to 5 ml | to 5 ml | to 5 ml | to 5 ml |

In other words, where solutions A, B, C and D are used to generate 100 dosage units, each is of a volume of 50 μl and comprises 1/100 of the quantities listed in the table.

5 ml of solution A contained in a manually operated nasal spray with a 50 μL dispenser delivers a dose of 10 mg of diamorphine hydrochloride. Solution B in a similar container will provide a unit dose of 20 mg.

The constituents of this mixture are stable in the dry state and in practice, quantities of the dry ingredients are weighed in the correct proportion, intimately mixed and aliquots weighed into amber glass containers. The containers are of the correct dimensions for use in the Advanced Dispensing System described previously.

The glass container is held within the cartridge of the Secure Dispensing Unit, and the pump head is supplied separately. 5 ml of Water for Injection in a plastic ampoule or graduated syringe is supplied separately as diluent. The syringe is connected with the outlet primary container. The pump mechanism is depressed and solvent is injected into the container, which is under negative pressure. Attachment of the syringe or plastic ampoule allows injection of the diluent. The syringe is removed and replaced by the pump unit, which then fits into the cartridge of the Advanced Dispensing System. Containment of the glass container in the cartridge both before and after reconstitution ensures integrity of the package and acts as a deterrent to diversion.

If required, the reconstitution can be carried out by a health professional, under supervision.

The dry contents of the vial may be introduced as a weighed quantity of powder. Alternatively, a solution containing the ingredients, after sterile filtration, is introduced into the vial and then freeze-dried. An advantage of using freeze-dried material is that it can be reconstituted very quickly.

All patents, patent applications, and published references cited herein are hereby incorporated by reference in their entirety. While this invention has been particularly shown and described with references to preferred embodiments thereof, it will be understood by those skilled in the art that various changes in form and details may be made therein without departing from the scope of the invention encompassed by the appended claims.

1. A dispenser comprising a reservoir containing a plurality of dosage units each of which comprise a formulation of a controlled drug or drug of abuse, said dosage units being contained in a tamper-evident manner such that access to the dosage units in use is controlled either by the dispenser or remotely and/or is monitored either by the dispenser or remotely.

2. The dispenser as claimed in claim 1, wherein the controlled drug or drug of abuse is a class A drug in a non-intravenous formulation, as defined by The Misuse of Drugs Act 1971.

3. The dispenser as claimed in claim 1, wherein the controlled drug or drug of abuse is an opioid.

4. The dispenser as claimed in claim 1, wherein the opioid is methadone or a pharmaceutically acceptable salt or derivative thereof.

5. The dispenser as claimed in claim 4, wherein the opioid is methadone hydrochloride.

6. The dispenser as claimed in claim 4, wherein the formulation is for oral delivery.

7. The dispenser as claimed in claim 1, wherein the opioid is diamorphine or a pharmaceutically acceptable salt or derivative thereof.

8. The dispenser as claimed in claim 7, wherein the opioid is diamorphine hydrochloride.

9. The dispenser as claimed in claim 7, wherein the formulation is dry and suitable for nasal delivery upon mixing with an aqueous solution.

10. The dispenser as claimed in claim 9, wherein the formulation further comprises a solubility enhancer.

11. The dispenser as claimed in claim 10, wherein the solubility enhancer is one or more of caffeine, sodium benzoate and sodium salicylate.

12. The dispenser as claimed in claim 10, wherein the solubility enhancer comprises caffeine and sodium benzoate and/or sodium salicylate.

13. The dispenser as claimed in claim 9, wherein said formulation is a freeze-dried formulation.

14. The dispenser as claimed in claim 1, wherein more than 1 day's supply of dosage units are contained in the dispenser.

15. A reservoir as claimed in claim 1, for use in the dispenser of claim 1.

16. A method of making a dispenser as defined in claim 1, comprising introducing the plurality of dosage units into the reservoir and then sealing the reservoir in the dispenser so as to render the dispenser tamper-evident.

17. A formulation as defined in claim 9.

18. A controlled method of taking a drug of abuse or a controlled drug comprising administering said drug of abuse or controlled drug from a dispenser as defined in claim 1.

19. A method as claimed in claim 18, wherein said drug of abuse or controlled drug is present in a formulation as defined in claim 9.

20. Use of a drug of abuse or a controlled drug in the manufacture of a medicament for use in a controlled method of taking a drug of abuse or controlled drug comprising administering said drug of abuse or controlled drug from a dispenser as defined in claim 1.

21. Use as claimed in claim 20, wherein said drug of abuse or controlled drug is present in a formulation as defined in claim 9.

22. A kit of parts comprising a dispenser as claimed in claim 9, and aqueous liquid for introduction into the dispenser for rendering the formulation suitable for nasal administration.
